(19) United States
(12) Patent Application Publication
(10) Pub. No.: US 2018/0281884 A1
(43) Pub. Date: Oct. 4, 2018

(54) Quick Release Axle Slider, A Motorcycle Crash Protection Device

(71) Applicant: Tom Chu, Dallas, TX (US)

(72) Inventor: Tom Chu, Dallas, TX (US)

(21) Appl. No.: 15/942,689

(22) Filed: Apr. 2, 2018

Related U.S. Application Data
(60) Provisional application No. 62/480,498, filed on Apr. 2, 2017.

(51) Int. Cl. B62J 23/00

(52) U.S. Cl. CPC B62J 23/00

(57) ABSTRACT

A quick release axle slider to be used with a motorcycle may include a slider base; a first magnetic ring to cooperate with the slider base; a rod to connect to the first magnetic ring; and a first fastener to extend through the slider base through the first magnetic ring and to connect to the rod.

### BACKGROUND OF THE INVENTION

While motorcycles are typically ridden so that they are somewhat perpendicular to the road surface, when rounding road curves, motorcycles lean away from the perpendicular. The leaning away from the perpendicular becomes especially apparent when motorcycles are raced, as the rider's knee will typically skim the surface of the racetrack because the motorcycles lean so close to the plane of the racetrack. There is an ever-present danger that the motorcycles will actually slide across the racetrack as they lose grip on the racetrack curve. In such cases, when the motorcycles' tires lose grip, the motorcycles typically slide and crash out of control. The motorcycle suffers expensive damage in such cases. An axle slider is a crash protection device that is attached to the axles of motorcycle to protect or minimize damage to a motorcycle as a result of a fall or crash.

A typical slider is made of plastic either of polyethylene material, and the material may vary in the form high density material, ultra high density material or acetal material. The typical slider is usually made in a set of four. Two are used on the front axle, and two are used on the rear axle. The typical slider is typically attached to the motorcycle using bolts or a threaded steel bar and nuts. In case of using bolts, a bolt is inserted into the center of a slider and screwed into a bar placed inside the bike axle. In case of using threaded steel bar and nuts, a threaded bar is inserted into a slider, run through the bike axle and through another slider on the opposite side of the axle. A nut will be screwed onto each end of the bar and then tightened. In either method, the installation and removal of sliders require tools and time up to several minutes.

### BRIEF SUMMARY OF THE INVENTION

A quick release axle slider to be used with a motorcycle may include a slider base; a first magnetic ring to cooperate with the slider base; a rod to connect to the first magnetic ring; and a first fastener to extend through the slider base through the first magnetic ring and to connect to the rod.

The quick release axle slider includes a second magnetic ring opposed to the first magnetic ring to connect to the rod.

The second fastener extends through the second magnetic ring.

A portion of the quick release axle slider is formed from polyethylene material

A portion of the quick release axle slider is formed from acetal material

Quick Release Axle Slider reduces the process to almost no time at all.

### BRIEF DESCRIPTION OF THE DRAWINGS

FIG. 1 illustrates an isometric view of motorcycle showing where the axle sliders attach to a motorcycle.

FIG. 2 illustrates a top view of motorcycle showing four quick release axle sliders.

FIG. 3 illustrates a perspective view of the quick release axle slider;

FIG. 4 illustrates an exploded view of the quick release axle slider;

FIG. 5 illustrates a front view of the first magnetic ring of the present invention;

FIG. 6 illustrates a side view of the first magnetic ring of the present invention;

FIG. 7 illustrates a front view of the second magnetic ring of the present invention;

FIG. 8 illustrates a side view of the second magnetic ring of the present invention;

FIG. 9 illustrates a perspective view of the quick release axle slider;

FIG. 10 illustrates a cross-sectional view of the quick release axle slider.

### DETAILED DESCRIPTION OF THE INVENTION

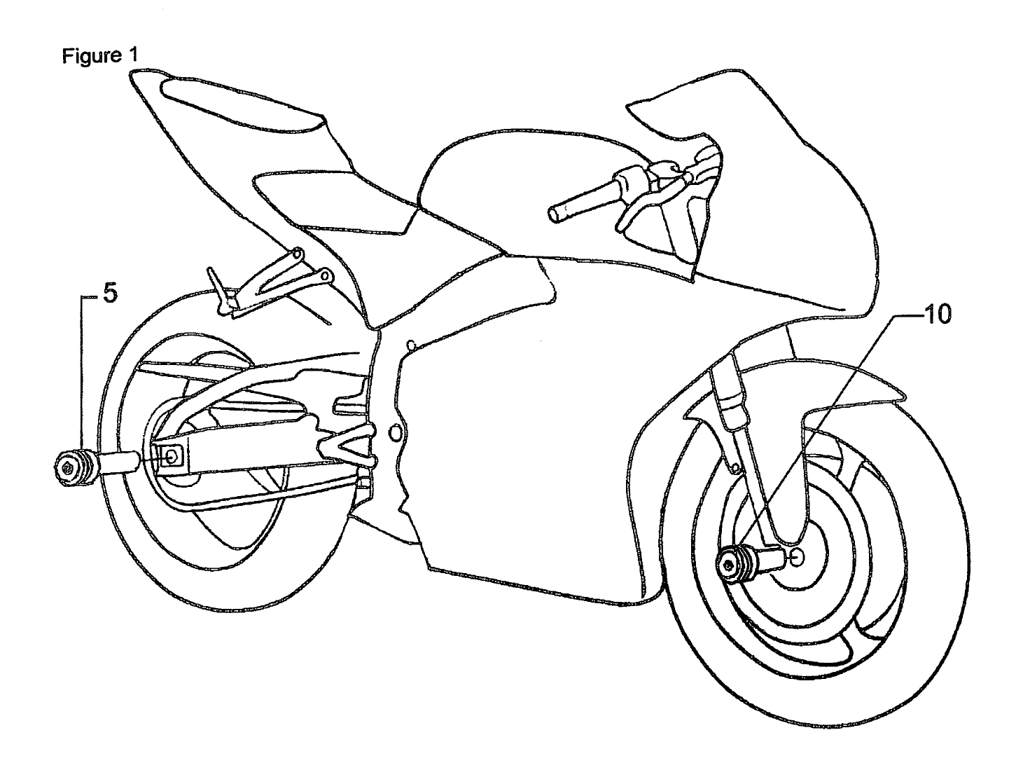

FIG. 1 illustrates an isometric view of the motorcycle showing the position where the quick release axle sliders 5 and 10 attach to a motorcycle. The back axle slider (5) is attached to rear axle of the motorcycle, and the front axle slider (10) is attached to front axle of the motorcycle.

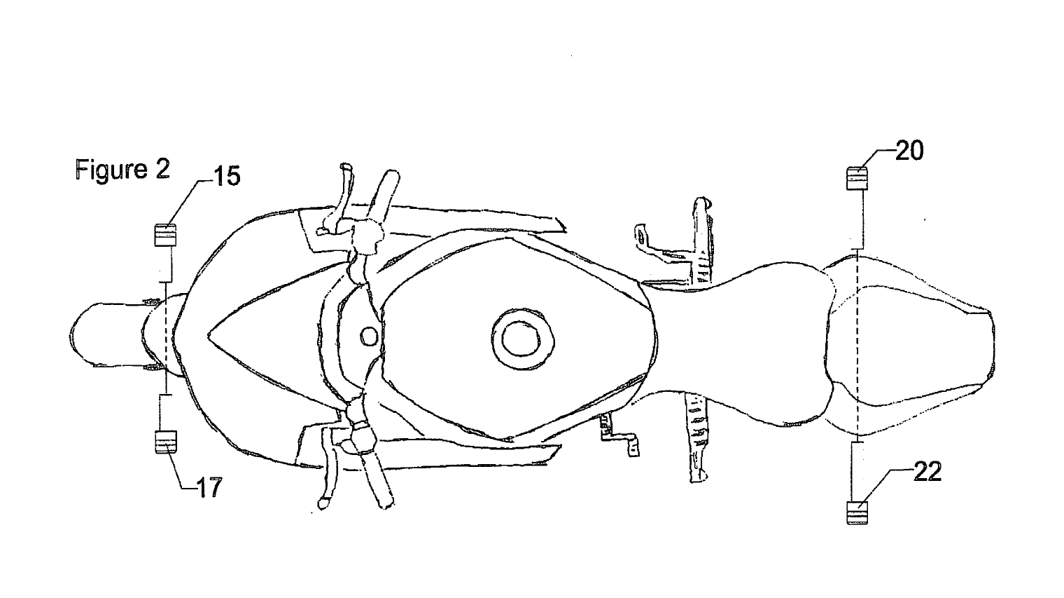

FIG. 2 illustrates a top view of motorcycle showing four axle sliders. One quick release slider 5, 10 attaches to each side of the axles of the motorcycle.

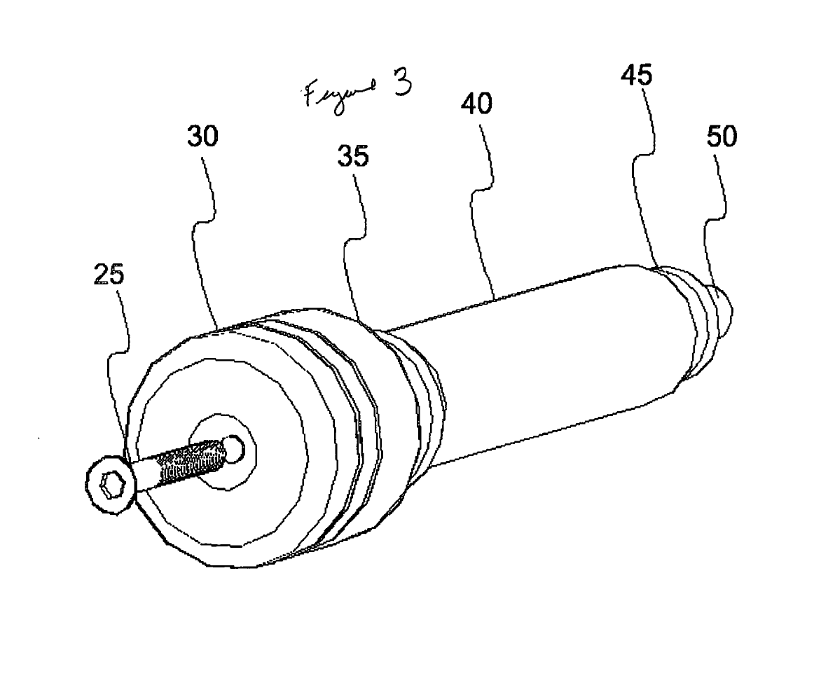

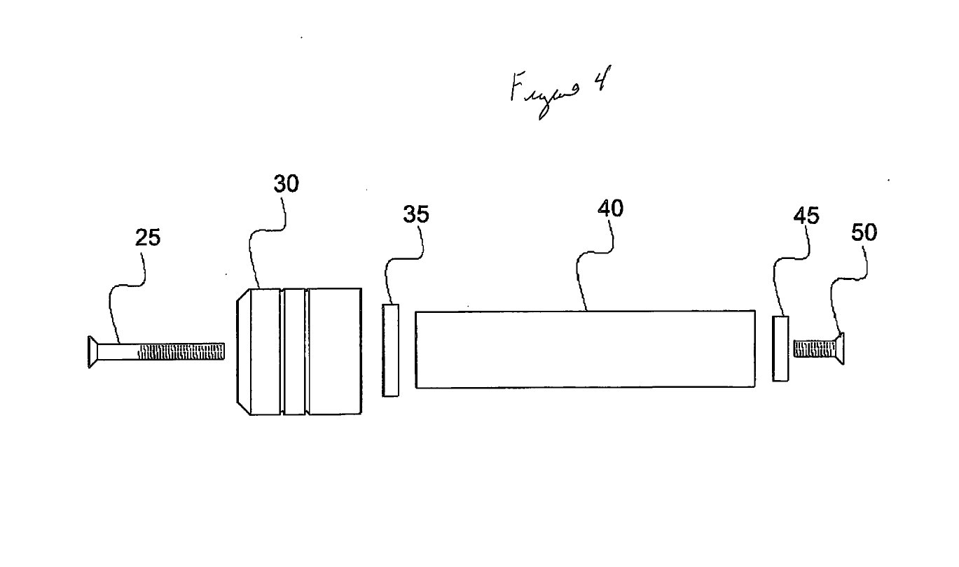

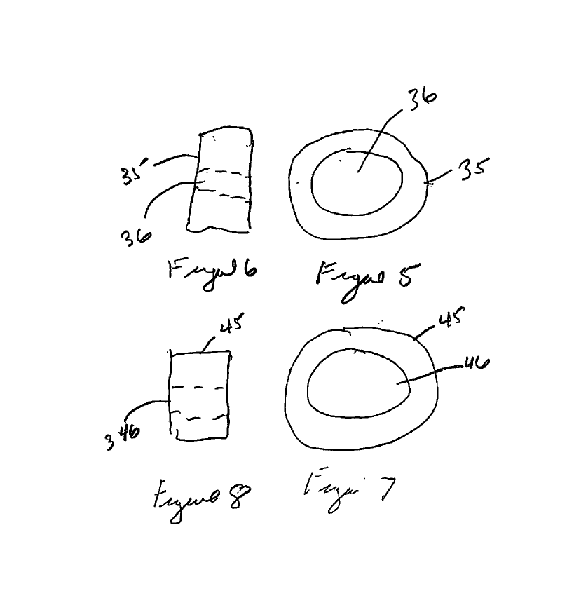

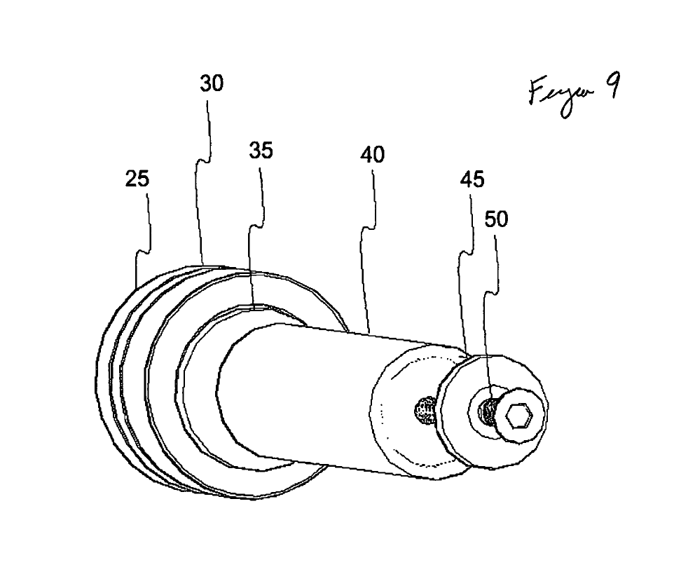

FIGS. 3, 4 and 9 illustrate the components of the quick release axle slider.

1

Front axle sliders and rear axle sliders are crash protection accessories. These sliders are attached to the front axle slider 10 to be positioned within the front axle of the motorcycle and rear axle slider 5 to be positioned within the rear axle of the motorcycle respectively (as depicted in FIG. 1). The function of the front axle slider 10 and the rear axle slider 5 is to reduce or minimize damage to the front forks and rear swing arms in the case of a fall or crash.

A quick release axle slider 5, 10 of the present invention requires no tools and reduces installation time to about two seconds. It is made of the same type of plastic as those of the typical slider. However, the quick release axle slider 5, 10 employs the use of a first magnetic ring 35 in order to retain the quick release axle slider 5, 10 within the front and rear axle. The first magnetic ring 35 may be formed from any magnetic material such as metal. Refer to FIG. 3. A first magnet ring (35) is attached to slider by using a first fastener 25 such as a bolt. This first fastener 25 is inserted into a slider base (30) to engage the magnetic ring 35, first magnet ring (35) with first center hole 36 and is connected for example by being screwed into a rod 40 which may be a plastic bar. The second magnet ring (45) with a second center hole 46 is connected to the opposing end of the rod 40 for example by being attached to the other end of the plastic bar using a second fastener 50 for example a bolt.

Installation of the quick release (QR) axle sliders is accomplished by inserting of the quick release sliders (15) and (17) into each opposing side of the front axle hole of the bike (refer to FIG. 2) and quick release sliders (20), (22) into the rear axle hole. Once the quick release axle sliders 15, 17, 20, 22 are inserted into both sides of each of the of the axles, they will be attached to each other by the second magnet rings (45). The quick release slider is also attached to the bike axle by the first magnet ring (35). Depending on motorcycle model, QR axle sliders (15), (17), (20) and (22) may be different in the dimension of length and diameter. Both the first and second magnetic rings (35) and (45) can be used on the same quick release slider 15, 17, 20, 22 or just one, either magnet ring (35) or (45) maybe use on the quick release slider 15, 17, 20, 22. Removal of the QR axle slider 15, 17, 20, 22 is achieved by a simple pulling on the quick release slider 15, 17, 20, 22 itself to detach the magnetic rings 35, 45.

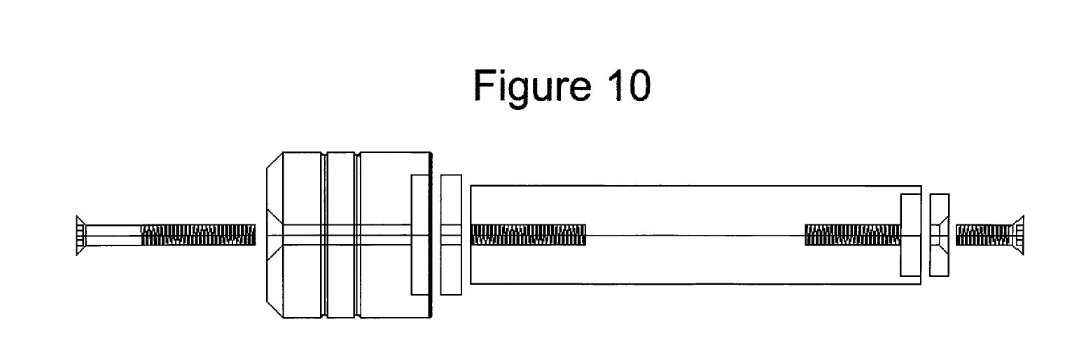

FIG. 10 illustrates a cross-sectional view of the quick release slider.

1) A quick release axle slider to be used with a motorcycle, comprising:
a slider base;
a first magnetic ring to cooperate with the slider base;
a rod to connect to the first magnetic ring;
a first fastener to extend through the slider base through the first magnetic ring and to connect to the rod.

2) A quick release axle slider to be used with a motorcycle as in claim 1, wherein the quick release axle slider further includes a second magnetic ring opposed to the first magnetic ring to connect to the rod.

3) A quick release axle slider to be used with a motorcycle as in claim 2, wherein a second fastener extends through the second magnetic ring.

4) A quick release axle slider to be used with a motorcycle as in claim 1, wherein a portion of the quick release axle slider is formed from polyethylene material

5) A quick release axle slider to be used with a motorcycle as in claim 1, wherein a portion of the quick release axle slider is formed from acetal material.
